(19) United States
(12) Patent Application Publication
(10) Pub. No.: US 2011/0137845 A1
(43) Pub. Date: Jun. 9, 2011

(54) METHOD AND APPARATUS FOR REAL TIME SEMANTIC FILTERING OF POSTS TO AN INTERNET SOCIAL NETWORK

(75) Inventor: Russell Craig WARD, Sun Prairie, WI (US)

(73) Assignee: ZEMOGA, INC., Wilton, CT (US)

(21) Appl. No.: 12/964,144

(22) Filed: Dec. 9, 2010

Related U.S. Application Data
(60) Provisional application No. 61/267,933, filed on Dec. 9, 2009.

(51) Int. Cl. G06N 5/02

(52) U.S. Cl. 706/50

(57) ABSTRACT

A method and apparatus for real time processing for mediating Social Media posts to a Social Media Network wherein a Semantic Filter Algorithm is provided. The Semantic Filter Algorithm is an application of Shannon's Entropy algorithm that functions to assess comparative contextual relationships between linguistic signifiers in a multiple of databases. Social Media posts are received by the Social Media Network and are automatically directed to Semantic filtering in multi-passes through the Semantic Filter Algorithm. The posts are automatically processed and an output is generated. Responsive to the output the posts are automatically allocated according to category and prioritized. Metatags are attached to the posts to control further processing regarding the various categories.

### BACKGROUND OF THE INVENTION

1. Field of the Invention

The present invention relates to a method and apparatus for real time semantic filtering of posts to an Internet social network controlled by an Internet based content management system wherein the real time semantic filter algorithm processes automatically and efficiently Social Media posts. Also, the invention relates to a computer readable media containing program instructions for real time semantic filtering of posts to an Internet social network, wherein the program instructions include processing automatically and efficiently Social Media posts.

2. Prior Art

Social Media posts to existing systems or Internet social networks are handled totally manually in that a moderator must review (read) every social media post to decide how it must be categorized and how is should be processed. As a result, this activity greatly increases the administrative costs of the system or network. Social Media Posts submitted to these manually moderated systems may be rejected due to inappropriate content and require manually generated email replies to explain the reason for the rejection.

In the Social Media space of the Internet, tens of thousands of web sites provide the opportunity for hundreds of millions of users to form communities while adding comments, posts or upload photographs and video 24 hours a day. A significant proportion of these sites utilize a moderator to review each comment or post manually to ensure the content is appropriate (devoid of offensive language, suggestions) material. In these cases for large sites the size of the review task can be huge because the volume of posts may be in the thousands. The process of editorial review for this content is time consuming, expensive and creates a further delay to approve or reject the posts.

Often in manually mediated sites the author of the post will not receive a response to his/her post submission for days or weeks, if ever, and his/her post may be excluded without adequate or any explanation. The legal implications of facilitating public conversations have effectively deterred many corporations from participating in such community site sponsorship or management. The current manual review process requires trained editorial staff to first screen all posts to categorize them into groups to expedite final regulatory review. Accordingly, a need exists to handle Social Media Posts in a more effective and efficient manner.

### SUMMARY OF THE INVENTION

A principal objective of the present invention is to provide a method and apparatus that operates in real time to efficiently process Social Media posts addressed to a Social Media site. This is accomplished by the present invention by the use of a method and apparatus wherein a real time Semantic Filter Algorithm coacts with an Internet Based Content Management System of a Social Media site. Each Post received by the Social Media site is directed automatically to the Semantic Filter Algorithm, which automatically efficiently processes each received Social Media Post. The novel Filter Algorithm utilizes a method of assessing comparative contextual relationships between linguistic signifiers. More particularly, in a first step, the Filter Algorithm applies a Shannon Entropy based algorithm H(X)=E(I(X)) to the Post text utilizing Semantic Elements, coded with priority and category meta-tags to identify content context of a Post entry, that have been preloaded into a Semantic Database. The application of the Shannon's Entropy algorithm is a novel application in a digital medium (Internet) and is designed for Social Media mediation. In second and succeeding steps, the Filter applies the Shannon's Entropy algorithm in multi-passes referencing differential Semantic Databases (White List and Blacklist) created specifically for Social Media Mediation, automatically categorizing and prioritizing the Social Media Post. Categorized and prioritized Posts are then placed into Post Category folders in a partitioned Post Database Archive. Based on the allocation of the Posts to Categories, the Categories trigger actions to direct Posts to (i) an Adverse Event Process, (ii) to be posted back to the Social Network location of submission for posting or (iii) processed as rejections via email to the Post originator. The Adverse Event Process identifies the primary qualifying criteria for reporting of an adverse Event according to regulating authority. The invention also has as an object a computer readable media containing program instructions for carrying out the method of the invention.

The invention further concerns a method and apparatus for automatic categorization and prioritization of Social Media Posts in conjunction with a third party Social Media site on the Internet or a local network, and more broadly, a method and apparatus for a novel automated application for the mediation of Social Media posts on the Internet or on a WAN or LAN.

This invention automatically filters, classifies, categorizes and channels for review or automated response, social media text posts. The invention reduces processing time and speeds up approval and posting time to social media sites. This invention reduces manual intervention required in the processing of such social media posts to save labor costs for the administrator or moderator. By reducing the social media post review and approval time, users will have a higher level of satisfaction with the social media user experience.

Other and further objects and advantages of the present invention will become more apparent from the following detailed description of preferred embodiments when taken in conjunction with the appended drawings.

### BRIEF DESCRIPTION OF THE DRAWINGS

FIG. 1 is a schematic block diagram illustrating a desktop or laptop computer interconnected via a wired or wireless connection to the Internet directly or via a cellular network and cellular device.

FIG. 2 is a block diagram showing the processing of Social Posts to a Social Network according to the method and apparatus of the present invention.

FIG. 3 is a block diagram showing in more detail the novel application of the Shannon's Entropy algorithm according to the method and apparatus of the present invention.

### DETAILED DESCRIPTION OF PREFERRED EMBODIMENTS OF THE INVENTION

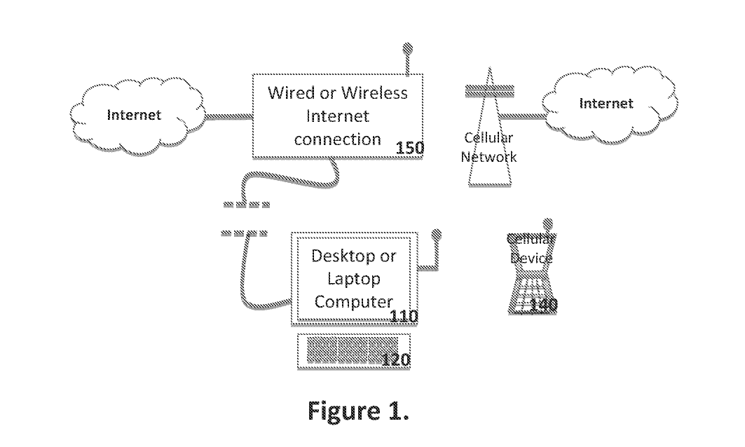

Referring initially to FIG. 1, shown is a typical set-up for a user to make social media post to a social network running on the Internet. In FIG. 1 the user with subscription or membership to a social network can create social posts to the social network using either a desktop or laptop computer 110 with keyboard 120 that has a wired or wireless Internet connection 150, or via a mobile computing device 140 that is connectable to the Internet by means of a cellular network 152. The social posts can be texts created by the computer or mobile computing device or voice to text applications.

In using this invention a Regulatory Review Committee would not necessarily need to review each post that included profane or explicit content. Conversely any content that included product names or adverse reaction information would need to be reviewed as a priority.

In FIG. 1 the user uses either a computer 110 with keyboard 120, voice to text application 130 or via a mobile computing device 140 that has an internet connection 150 and subscription or membership to the social network.

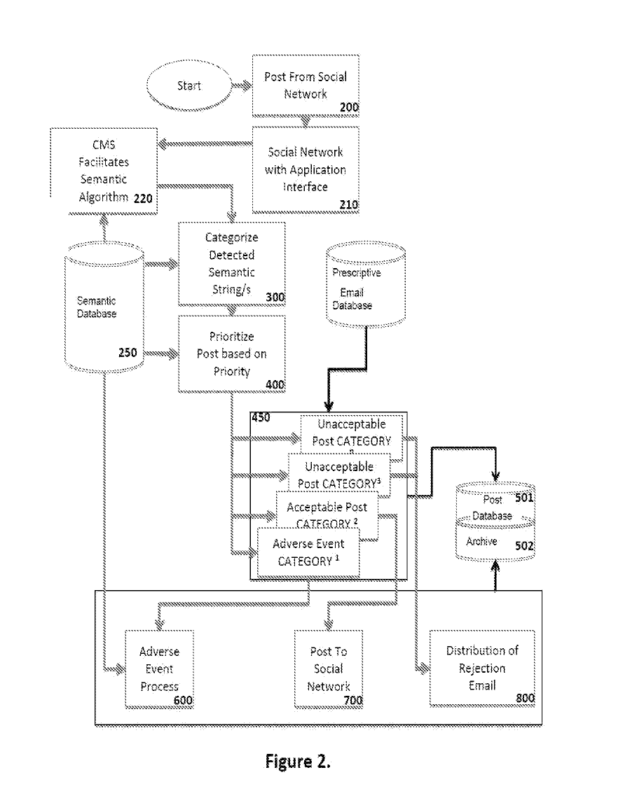

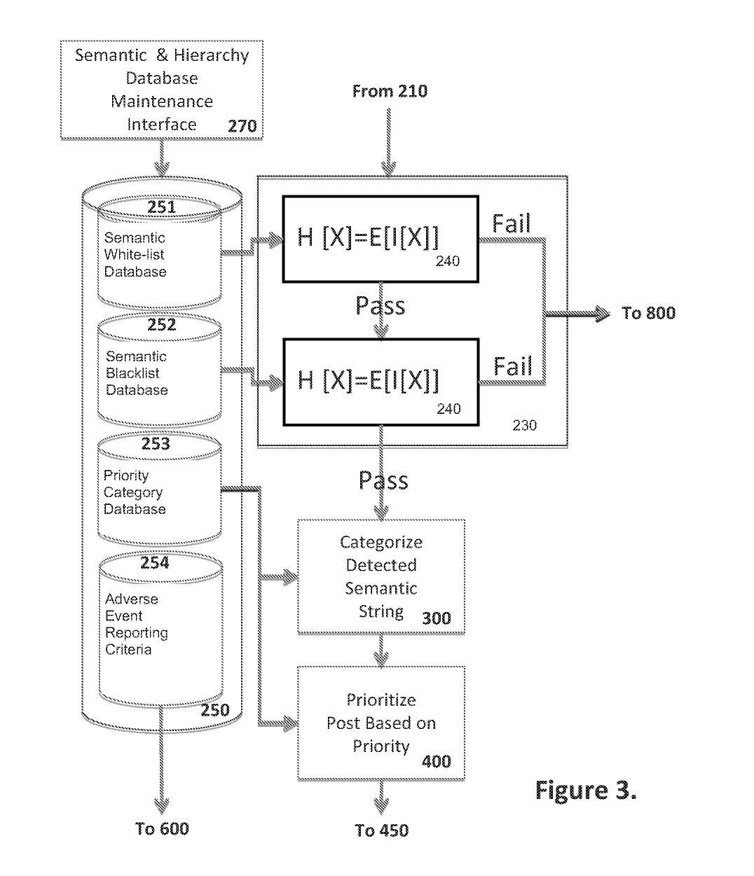

Referring now to FIGS. 2 and 3 after the user has initiated a Post 200 on an Internet based Social Network (e.g. provider—Badoo, Bedo, Habbo, Linkedin, Facebook, MySpace, etc.) that is equipped with a content management system (CMS) 220 that operates as a functional part of the provider's Social Network, the Post 200 is received and picked up by Application Interface 210 of the Social Network, which includes a Content Management System (CMS) that is a custom application that contains content and information processing capabilities. Through the Content Management System 220 the CMS facilitates the processing of the Post using an integrated Semantic Algorithm processor 230 with respect to a pre-defined series of semantic terms, which are preloaded into a Semantic Database 250 composed of a Semantic White-list Database 251, a Semantic Blacklist Database 252 and a Priority Category Database 253. Also contained in the database 250 is Adverse Event Reporting Criteria 254. A Semantic & Hierarchy Database Maintenance Interface 270 maintains and updates the database 250. The Semantic & Hierarchy Database Maintenance Interface 270 also preloads into Semantic Database 253 predetermined Semantic Elements coded with priority and category metatags.

Referring to FIGS. 2 and 3, the Semantic Algorithm processor 230 initially applies a Shannon Entropy based algorithm H(X)=E(I(X)) 240 to the Post text utilizing semantic elements loaded in Semantic White-list Database 251 to identify content context of the Post entry. Each Post passes from the Application Interface 210 to the CMS 220 and to the integrated Semantic Algorithm processor 230 and is processed through the algorithm 240, in order to determine if it meets preset linguistic validation requirements. Elements within the Post that fail the linguistic validation requirements result in the entire post being rejected and processed as Rejection Emails 800, and are appropriately distributed back to the originating user.

Posts that pass the linguistic validity requirement in the first pass through the Semantic Algorithm 230 are validated and passed a second time through the Semantic Algorithm processor 230 and again processed via the algorithm 240, this time using Semantic Blacklist Database 252. Elements within the Post that fail Blacklist processing result in the entire post being rejected and routed to and processed as Rejection Emails 800, and appropriately distributed back to the originating user.

The product of the algorithm processing (Post) is then passed to Categorize Detected Semantic String 300 and Prioritize Post Based on Priority 400 according to predetermined metatags associated with the Semantic Elements from the Semantic Database 253, and placed into the appropriate one of the 1−n folders in Post Category folders 450, and also on the partitioned Post Database Archive 501. All data results are saved to the partitioned Post Database Archive 501. All data can be accessed, searched and reviewed as required.

Based on the allocation of Posts to a folder in the Post Category folders 450, the allocated Category (1, 2, 3 . . . n) triggers an action of directing the Post to one of (i) Adverse Event Process 600, (ii) Post to Social Network 700 (location of submission for posting) or (iii) Distribution of Rejected Email 800 to be processed as a rejection via email to the Post originator.

The Adverse Event Process 600 identifies the primary qualifying criteria 254 for reporting of an Adverse Event according to the FDA DDAMC. This process would be updated from time to time as the FDA publishes changes.

All data results are saved to the partitioned Post Database Archive 501. All data can be accessed, searched and reviewed as required. Acceptable Posts, Rejected Posts and Adverse Event Posts [600, 700, 800] are recorded in the Database Archive functions 502.

In the method and apparatus of the invention, the Shannon's Entropy algorithm is an indirect application of Shannon's Information Theory, i.e. it is not used as a measure of uncertainty to which several theorems of Shannon's Entropy can also be applied, but rather as a specific adaption of Shannon's Mathematical Theory of Communication. In the context of the invention, a social media post contains semantic elements as the information source contains discrete random variables stated as “X” (words or signifier's within a given written language) from a finite number of possible values (total words or signifier's within the written language). These elements are then transmitted (in digital form across the Internet) and the first pass of the algorithm identifies the variables as linguistically valid. Linguistic validity defines that a specific signifier actually belongs to the signifiers within the written language and that these signifiers have no data compression (hidden meaning due to compression) or altered form (signifier substitution).

As an example of compression this would exclude contemporary coded terms like LOL that is used for “laugh out loud”, TTYL “talk to you later” or OMFG “oh my fucking god”.

In the case of substitution, this first pass application of the filter identifies other random variables that are modified from the original signifier in attempt to “cloak” such signifier's by replacing valid signifier's with others, for example f#ck “fuck”, ci@lis “cialis” and billions of other potential substitution combinations. The filter method and apparatus quantifies the expected value of the random variable contained in the post and rejects the entire post based on the values quantified that do not belong in the standard written language. This first pass filter draws it's signifiers from a programmable database identified as the “White List” or valid linguistic of semantic elements.

The second pass of the filter incorporates signifiers that may be valid in a specific written language but have been identified as inappropriate to be included in the publication of a social media post based on the degree of risk associated with such signifiers. The identification of these signifiers is formulated by industry and contemporary and contextual signifier use. These valid signifiers within the written language set carry meaning that can contravene regulatory requirements of a government (US Government), specific authority (FDA DDMAC) or entity (Medical Company). Further, these signifiers may include claims that can involve competitive product, product performance claims, unsubstantiated claims of causes, effects or impact and other claims that may be slanderous or misrepresentative of the class. In some cases the invention (filter) quantifies the expected value of the random variable contained in a post and rejects the entire post or passes the post into the categorization/prioritization stage. This second pass through the invention (filter) draws on a programmable database identified as the “Blacklist” or signifiers that are determined to potentially precipitate risk for the page or channel sponsor (independent company) of the social media service (Facebook, Twitter etc.).

In the Categorization and Prioritization step of the method and apparatus, the post content is analyzed for the existence of specific signifiers and based on the findings assigns a predetermined category to the post by the inclusion of a metatag to the post. The categories are programmable so the administrator can determine how to manage the posts most efficiently. These categories can include “acceptable posts”, posts that contain potential “adverse events” that may need to be reported to a review committee and posts that are unacceptable. Of these categorized posts, a priority is also included in each as a metatag with the post. The metatag defines a processing priority. An example of this priority would be for “adverse Events” to be processed first while acceptable posts would be processed next and unacceptable and rejected posts processed last.

As is evident from FIG. 2, a Prescriptive Email Database, shown coupled to Categories 450, provides email texts to assist in the reporting of the output of the system. This database carries a list of pre-prescribed and approved (by the corporate sponsor of the social media service) email body texts that are applied to specific rejections of posts from the system. These body texts can contain notification to submitters (public participating in the specific social media application) for various reasons, for example, the failure of the post submitter to conform to the published posting guidelines found on the page/s of the companies social media location. These guidelines may indicate that the use of inappropriate language, trade names, identity names, celebrities, politicians, company names and products or services will cause the post to be rejected.

Once a post has been categorized and prioritized it is then subject to an Adverse Event Processing that passes the post through a set of routing and escalation rules. These rules are stored in the programmable database and can be updated as government, authority and business regulatory reporting rules evolve. An example of this may be to direct identified posts to a specific group of accountable individuals via email, text message or automated voice call.

The necessary elements for the successful operation of the invention comprise the Content Management System 220, the Semantic Databases [250, 252, 252, 253, 270], Semantic Filter algorithm processor [230, 240], the Prioritization and Categorization process [300, 400], the Category Folders [450], the Automated Posting and Email functions [600, 700, 800], and recording of the Acceptable Posts, Rejected Posts and Adverse Event Posts [600, 700, 800] in the Database Archive functions 502, and the Prescriptive Email Database.

The essential flow of this invention takes any text of interest and filters it with the Semantic Algorithm to detect specific Semantic Elements. The prioritization and classification of the filter results are then processed through the administration of the Semantic & Hierarchy Maintenance Interface [270] in conjunction with the Priority Category Database 253. The Semantic Filter can be applied in any situation where text filtering for specific semantic terms is desirable.

The invention operates via accessibility from desktop, laptop and cellular phones that have broadband Internet connection and a suitable internet browser function. See FIG. 1. The invention also includes a computer readable media containing program instructions for carrying out the method of the invention. The computer readable media is readable by any computer included in the Social Media Network or by any PC, Apple Macintosh or main frame.

The Semantic Filter has the ability to run in association with word processors and other computer based text processing systems like SMS texting systems for cell phones.

A secondary capability of this application is to provide qualitative research data from a Cultural Anthropological framework that can be extracted from the actual conversations (Posts) within the system. This extracted data can be analyzed for content and context to develop theoretical models.

Existing systems are totally manual in that a moderator must review (read) every social media post to decide how it must be categorized and how is should be processed attracting administrative costs. Posts submitted to these manually moderated systems may be rejected due to inappropriate content and require manually generated email replies to explain the reason for the rejection.

In the Social Media space of the Internet, tens of thousands of web sites provide the opportunity for hundreds of millions of users to form communities while adding comments, posts or upload photographs and video 24 hours a day. A significant proportion of these sites utilize a moderator to review each comment or post manually to ensure the content is appropriate (devoid of offensive language, suggestions) material. In these cases for large sites the size of the review task can be huge because the volume of posts may be in the thousands. The process of editorial review for this content is time consuming, expensive and creates a further delay to approve or reject the posts. Often in manually mediated sites the author of the post will not receive a response to their post submission for days or weeks if ever and their post may be excluded without adequate or any explanation. The legal implications of facilitating public conversations have effectively deterred many corporations from participating in such community site sponsorship or management. The current review process requires trained editorial staff to first screen all posts to categorize them into groups to expedite final regulatory review. In using the present invention a Regulatory Review Committee would not necessarily need to review each post that included profane or explicit content. Conversely, any content that included product names or adverse reaction information would need to be reviewed as a priority.

Although the present invention has shown and described in terms of preferred embodiments, nevertheless changes and modification will occur to those of ordinary skill in the art that do not depart from the inventive teachings herein. Accordingly, such changes and modifications are deemed to fall within the purview of the appended claims.

What is claimed is:

1. A method for real time processing for mediating Media posts to an Internet site comprising the steps of providing a Semantic Filter Algorithm, automatically directing Media posts received by the Internet site to Semantic filtering through the Semantic Filter Algorithm, and automatically processing directed posts and generating an output, and responsive to said output automatically accepting or rejecting the posts, said Semantic Filter Algorithm functioning to assess comparative contextual relationships between linguistic signifiers.

2. A method for real time processing for mediating Social Media posts to a Social Media Network comprising the steps of providing a Semantic Filter Algorithm, automatically directing Social Media posts received by the Social Media Network to Semantic filtering through the Semantic Filter Algorithm, and automatically processing directed posts and generating an output, and responsive to said output automatically allocating the posts according to categories, said Semantic Filter Algorithm functioning to assess comparative contextual relationships between linguistic signifiers.

3. The method of claim 2 wherein the Semantic Filter Algorithm is an application of Shannon's Entropy algorithm.

4. The method of claim 2 wherein the Social Media Network includes an Internet Based Content Management with which the Semantic Filter Algorithm is integrated.

5. The method of claim 2 wherein received posts are successively filtered a plurality of time by passing through the Semantic Filter Algorithm referencing differential Semantic Databases.

6. The method of claim 2 including the further step of automatically metatagging the received posts as to category and priority.

7. Apparatus for real time processing for mediating Media posts to an Internet site comprising means providing a Semantic Filter Algorithm processing device, means for automatically directing Media posts received by the Internet site to Semantic filtering through the Semantic Filter Algorithm device, and means for automatically processing directed posts and generating an output, and means responsive to said output for automatically accepting or rejecting the posts, said Semantic Filter Algorithm device functioning to assess comparative contextual relationships between linguistic signifiers.

8. Apparatus for real time processing for mediating Social Media posts to a Social Media Network comprising means providing a Semantic Filter Algorithm processing device, means for automatically directing Social Media posts received by the Social Media Network to Semantic filtering through the Semantic Filter Algorithm device, and means for automatically processing directed posts and generating an output, and means responsive to said output for automatically allocating the posts according to categories, said Semantic Filter Algorithm device functioning to assess comparative contextual relationships between linguistic signifiers.

9. Apparatus of claim 8 wherein the Semantic Filter Algorithm device operates an application of Shannon's Entropy algorithm.

10. Apparatus of claim 8 wherein the Social Media Network includes an Internet Based Content Management and means are provided to integrate the Semantic Filter Algorithm device therewith.

11. Apparatus of claim 8 wherein said means for automatically directing Social Media posts received by the Social Media Network to Semantic filtering through the Semantic Filter Algorithm device operates to successively filtered received posts a plurality of time by passing through the Semantic Filter Algorithm device referencing differential Semantic Databases.

12. Apparatus of claim 8 including means for automatically metatagging the received posts as to category and priority.

13. A computer readable medium having computer executable program code thereon including: first program logic for real time mediating Media posts to an Internet site; second program logic for processing Media posts through a Semantic Filter Algorithm; third program logic for automatically directing Media posts received by the Internet site to Semantic filtering through the Semantic Filter Algorithm, and fourth program logic for automatically processing directed posts and generating an output, fifth program logic for responsive to said output for automatically accepting or rejecting the posts, and sixth program logic for controlling said Semantic Filter Algorithm to function to assess comparative contextual relationships between linguistic signifiers.

14. A computer readable medium having computer executable program code thereon including: first program logic for real time mediating Social Media posts to a Social Media Network; second program logic for processing Media post through a Semantic Filter Algorithm; third program logic for automatically directing Social Media posts received by the Social Media Network to Semantic filtering through the Semantic Filter Algorithm, fourth program logic for automatically processing directed posts and generating an output, fifth program logic responsive to said output for automatically allocating the posts according to categories, and sixth program logic for controlling said Semantic Filter Algorithm to function to assess comparative contextual relationships between linguistic signifiers.

15. A computer readable medium according to claim 14 wherein the Semantic Filter Algorithm is an application of Shannon's Entropy algorithm.
